(19) United States
(12) Patent Application Publication
(10) Pub. No.: US 2017/0111064 A1
(43) Pub. Date: Apr. 20, 2017

(54) DISTORTION COMPENSATION DEVICE

(71) Applicant: FUJITSU LIMITED, Kawasaki-sh (JP)

(72) Inventors: Tomoya Ota, Kawasaki (JP); Hiroyoshi Ishikawa, Kawasaki (JP); Kazuo Nagatani, Yokohama (JP)

(73) Assignee: FUJITSU LIMITED, Kawasaki-sh (JP)

(21) Appl. No.: 15/268,081

(22) Filed: Sep. 16, 2016

(30) Foreign Application Priority Data
Oct. 14, 2015 (JP) 2015-203230

(51) Int. Cl. H04B 1/04

(52) U.S. Cl. CPC H04B 1/0475; H04B 1/0466; H04B 2001/0425

(57) ABSTRACT

A distortion compensation device includes an address generating unit, a look up table (LUT), and a multiplier. The address generating unit calculates pieces of difference information for different combinations each including transmission signals at different timings. Each of the pieces of difference information is the difference in amplitude or power between the transmission signals in a corresponding one of the combinations. The LUT specifies a distortion compensation coefficient by using the above pieces of difference information calculated by the address generating unit. The multiplier performs predistortion, using a distortion compensation coefficient specified by the LUT, on a transmission signal to be input to an amplifier.

### CROSS-REFERENCE TO RELATED APPLICATION

This application is based upon and claims the benefit of priority of the prior Japanese Patent Application No. 2015-203230, filed on Oct. 14, 2015, the entire contents of which are incorporated herein by reference.

### FIELD

The embodiments discussed herein are related to a distortion compensation device.

### BACKGROUND

A radio transmitter device includes an amplifier that amplifies power of transmission signals. Generally in a radio transmitter device, an amplifier is operated near the saturation region of the amplifier so that the power efficiency of the amplifier can be higher. However, when an amplifier is operated near the saturation region thereof, relatively large nonlinear distortion occurs to the amplifier. For this reason, a radio transmitter device includes a distortion compensation device so as to suppress such nonlinear distortion to have a lower adjacent channel leakage ratio (ACLR).

Distortion compensation methods employed by distortion compensation devices include a “predistortion (hereinafter also referred to as “PD”) method”. In a distortion compensation device employing a PD method, a transmission signal to be input to an amplifier is multiplied by a distortion compensation coefficient, before being input. The distortion compensation coefficient has an inverse characteristic of nonlinear distortion of the amplifier. Consequently, output from the amplifier is more highly linearized, so that distortion of the output from the amplifier is reduced.

In addition, it is known that a phenomenon called a memory effect occurs in an amplifier having high power efficiency. A memory effect is a phenomenon in which output from the amplifier corresponding to input at a certain time point is affected by input in the past. Distortion compensation methods for compensating nonlinear distortion in an amplifier include a method that compensates not only nonlinear distortion but also a memory effect. In such a method, for example, a distortion compensation coefficient is determined by use of information on the difference between the amplitude of a transmission signal and the amplitude of a signal obtained by delaying the transmission signal by a certain time period. In addition, the time period by which the transmission signal is delayed is adjusted so as to be matched with the time constant of the memory effect. Related-art examples are described in Japanese Laid-open Patent Publication No. 2010-183310.

Here, the time constants of memory effects in an amplifier are not uniformly determined, and there are different memory effects having different time constants. For this reason, when the difference between the amplitude of a transmission signal and the amplitude of one signal obtained by delaying the transmission signal by a certain time period is used, it is difficult to reduce distortion resulting from a memory effect having a different time constant.

### SUMMARY

According to an aspect of an embodiment, a distortion compensation device includes a calculating unit, a specifying unit, and a distortion compensation unit. The calculating unit calculates pieces of difference information for different combinations each including transmission signals at different timings, the pieces of difference information each being a difference in amplitude or power between the transmission signals in a corresponding one of the combinations. The specifying unit specifies a distortion compensation coefficient by using the pieces of difference information calculated by the calculating unit. The distortion compensation unit performs predistortion, using the distortion compensation coefficient specified by the specifying unit, on the transmission signals to be input to an amplifier.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a distortion compensation device in a first embodiment;

FIG. 2 is a block diagram illustrating an example of an address generating unit in a second embodiment;

FIG. 3 is a diagram explaining examples of a transmission signal band and a distortion compensation band;

FIG. 4 is a block diagram illustrating an example of a distortion compensation device in a third embodiment;

FIG. 5 is a block diagram illustrating an example of a distortion compensation device in a fourth embodiment;

FIG. 6 is a block diagram illustrating an example of an address generating unit in a fifth embodiment;

FIG. 7 is a diagram illustrating hardware of a distortion compensation device;

FIG. 8 is a block diagram illustrating another exemplary address generating unit;

FIG. 9 is a block diagram illustrating another exemplary address generating unit; and

FIG. 10 is a block diagram illustrating another exemplary address generating unit.

### DESCRIPTION OF EMBODIMENTS

Preferred embodiments of the present invention will be explained with reference to accompanying drawings. The following embodiments are not intended to limit a distortion compensation device disclosed by the present application. Any two or more of the embodiments can be combined to the extent that no inconsistency occurs among processes therein.

### First Embodiment

Distortion Compensation Device 10

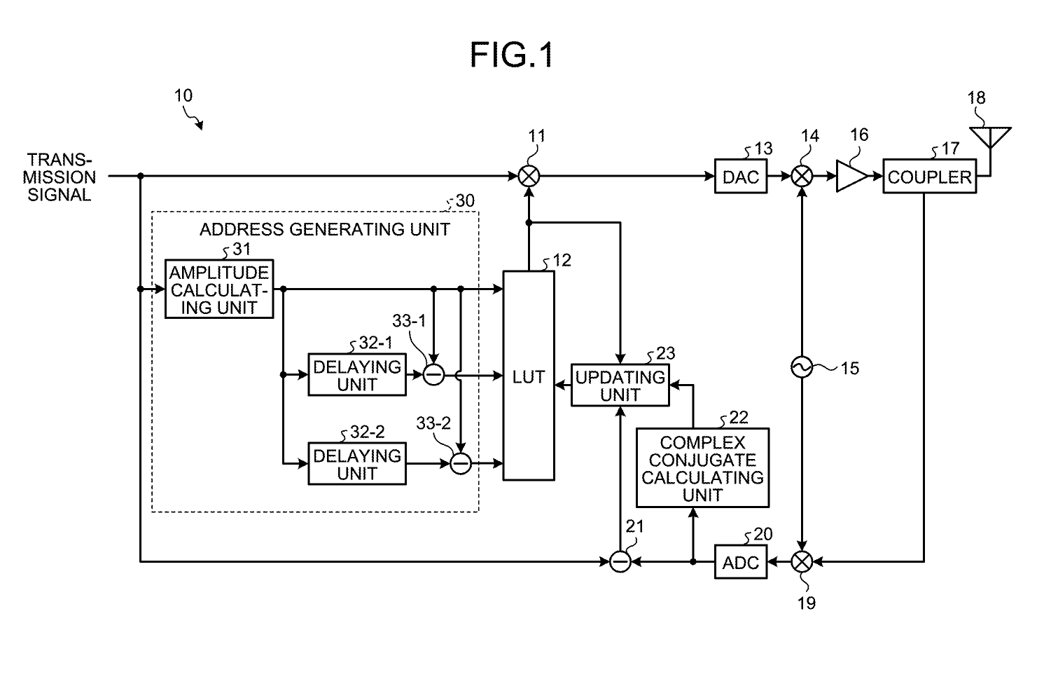

FIG. 1 is a block diagram illustrating an example of a distortion compensation device 10 in a first embodiment. The distortion compensation device 10 in the first embodiment includes a multiplier 11, a look up table (LUT) 12, a digital to analog converter (DAC) 13, an upconverter 14, an oscillator 15, an amplifier 16, a coupler 17, and an antenna 18. The distortion compensation device 10 in the first embodiment further includes a downconverter 19, an analog to digital converter (ADC) 20, a subtractor 21, a complex conjugate calculating unit 22, an updating unit 23, and an address generating unit 30. For example, in a radio communication system including a base station and a terminal, the distortion compensation device 10 is installed in either the base station or the terminal, or in both of them.

The address generating unit 30 calculates pieces of difference information for different combinations each including transmission signals at different timings. Each of the pieces of difference information is the difference between the amplitudes of the transmission signals in one of the above combinations. The address generating unit 30 outputs the calculated pieces of difference information and the amplitudes of the transmission signals, as addresses, to the LUT 12. The address generating unit 30 is an example of a calculating unit.

The address generating unit 30 includes an amplitude calculating unit 31, a delaying unit 32-1, another delaying unit 32-2, a subtractor 33-1, and another subtractor 33-2. Hereinafter, the delaying unit 32-1 and the delaying unit 32-2 are collectively referred to as delaying units 32 when these units are referred to generically without being differentiated from each other; and the subtractor 33-1 and the subtractor 33-2 are collectively referred to as the subtractor 33 when these units are referred to generically without being differentiated from each other.

The amplitude calculating unit 31 calculate the amplitude of a transmission signal. The amplitude calculating unit 31 calculates, for example, the square root of the sum of the squares of the I and Q components of a transmission signal as the amplitude of the transmission signal. The amplitude calculating unit 31 then outputs a value for the calculated amplitude of the transmission signal, as a first address, to the LUT 12. The amplitude calculating unit 31 is an example of a first amplitude calculating unit.

The delaying unit 32-1 delays, by a first time period ΔT1, the value for the amplitude of a transmission signal calculated by the amplitude calculating unit 31. The delaying unit 32-1 is an example of a first delaying unit. The subtractor 33-1 calculates, as a piece of difference information, the difference between the value for the amplitude of a transmission signal calculated by the amplitude calculating unit 31 and a value for an amplitude of the transmission signal obtained by delaying by the delaying unit 32-1. The subtractor 33-1 then outputs the calculated piece of difference information, as a second address, to the LUT 12. The subtractor 33-1 is an example of a first difference calculating unit.

The delaying unit 32-2 delays, by a second time period ΔT2, the value of the amplitude of the transmission signal calculated by the amplitude calculating unit 31. The delaying unit 32-2 is an example of a second delaying unit. The subtractor 33-2 calculates, as a piece of difference information, the difference between the value for the amplitude of a transmission signal calculated by the amplitude calculating unit 31 and a value for an amplitude of the transmission signal obtained by delaying by the delaying unit 32-2. The subtractor 33-2 then outputs the calculated piece of difference information, as a third address, to the LUT 12. The subtractor 33-2 is an example of a second difference calculating unit.

The LUT 12 specifies a distortion compensation coefficient by using the pieces of difference information calculated by the address generating unit 30. Specifically, the LUT 12 retains distortion compensation coefficients with these coefficients associated with combinations of the first addresses, the second addresses, and the third addresses. When the address generating unit 30 has output the first address, the second address, and the third address, the LUT 12 specifies a distortion compensation coefficient associated with the combination of these addresses. The LUT 12 then outputs the specified distortion compensation coefficient to the multiplier 11. The LUT 12 is an example of a specifying unit.

Although the address generating unit 30 according to the first embodiment includes the two delaying units 32 and the two subtractors 33, the techniques disclosed herein are not limited to this example and the address generating unit 30 may include equal to or more than three delaying units 32 and equal to or more than three subtractors 33. In this case, the LUT 12 specifies a distortion compensation coefficient associated with the combination of the first address output from the amplitude calculating unit 31 and the addresses output from the respective subtractors 33, and outputs the specified distortion compensation coefficient to the multiplier 11.

The multiplier 11 performs predistortion, using the distortion compensation coefficient specified by the LUT 12, on the transmission signal to be input to the amplifier 16. Specifically, the multiplier 11 performs predistortion on the transmission signal by multiplying the transmission signal by the distortion compensation coefficient output from the LUT 12. The multiplier 11 then outputs, to the DAC 13, the transmission signal after the predistortion (hereinafter referred to as PD signal). The multiplier 11 is an example of a distortion compensation unit.

The DAC 13 converts the PD signal output from the multiplier 11 from a digital signal into an analog signal. The DAC 13 then outputs the converted PD signal to the upconverter 14.

The upconverter 14 upconverts the PD signal converted into an analog signal, using a local oscillator signal output from the oscillator 15. The upconverter 14 then outputs the upconverted PD signal to the amplifier 16.

The amplifier 16 amplifies the power of the upconverted PD signal. The amplifier 16 then outputs the amplified signal to the coupler 17.

The coupler 17 outputs the signal amplified by the amplifier 16 to the antenna 18 and feeds a part of the signal back to the downconverter 19. The signal output to the antenna 18 is emitted into a space from the antenna 18.

The downconverter 19 downconverts the signal fed back from the coupler 17, using a local oscillator signal output from the oscillator 15. The downconverter 19 then outputs the downconverted signal to the ADC 20.

The ADC 20 converts the downconverted signal from an analog signal to a digital signal. The ADC 20 the outputs the converted digital signal to a subtractor 21 and to a complex conjugate calculating unit 22.

The subtractor 21 calculates the difference between the transmission signal and the signal output from the ADC 20. A signal corresponding to the difference calculated by the subtractor 21 may sometimes be called an error signal. The subtractor 21 outputs the signal corresponding to the calculated difference to the updating unit 23. The subtractor 21 is an example of an error calculating unit.

The complex conjugate calculating unit 22 calculates a complex conjugate of the signal output from the ADC 20. The complex conjugate calculating unit 22 then outputs a signal corresponding to the calculated complex conjugate to the updating unit 23.

The updating unit 23 calculates an updated distortion compensation coefficient based on the distortion compensation coefficient output from the LUT 12, the error signal output from the subtractor 21, and the signal corresponding to the complex conjugate output from the complex conjugate calculating unit 22. The updating unit 23 calculates the updated distortion compensation coefficient using, for example, an algorithm such as the Least Mean Square (LMS) algorithm or the Recursive Least Squares (RLS) algorithm. The updating unit 23 then updates the distortion compensation coefficient retained in the LUT 12 to the calculated updated distortion compensation coefficient.

### Effects of First Embodiment

As is clear from the above explanation, in the distortion compensation device 10 according to the first embodiment, the address generating unit 30 calculates pieces of difference information for different combinations each including transmission signals at different timings. Each of the pieces of difference information is the difference between the amplitudes of the transmission signals in one of the combinations. The LUT 12 then specifies a distortion compensation coefficient by using the pieces of difference information calculated by the address generating unit 30. The multiplier 11 then performs predistortion, using the distortion compensation coefficient specified by the LUT 12, on a transmission signal to be input to the amplifier 16. The distortion compensation device 10 is thus enabled to specify distortion compensation coefficients that compensate time constant components of memory effects having a plurality of time constants. Therefore, the distortion compensation device 10 is enabled to reduce distortion in the amplifier 16 attributable to memory effects even when these memory effects have different time constants.

Furthermore, in the distortion compensation device 10 according to the first embodiment, the LUT 12 specifies a distortion compensation coefficient using, as addresses, a plurality of pieces of difference information calculated by the address generating unit 30.

Consequently, as compared with when pieces of information on the amplitudes at different timings are used as addresses, the number of bits used for addresses associated with each distortion compensation coefficient can be reduced. Therefore, the amount of data in the LUT 12 can be reduced, and the distortion compensation device 10 can be reduced in size.

### Second Embodiment

The distortion compensation device 10 according to a second embodiment differs from the distortion compensation device 10 according to the first embodiment in that delay amounts that the delaying unit 32-1 and the delaying unit 32-2 apply are variable. The entire configuration of the distortion compensation device 10 is the same as the one according to the first embodiment except for the address generating unit 30. For this reason, the configuration of the address generating unit 30 will be mainly explained below.

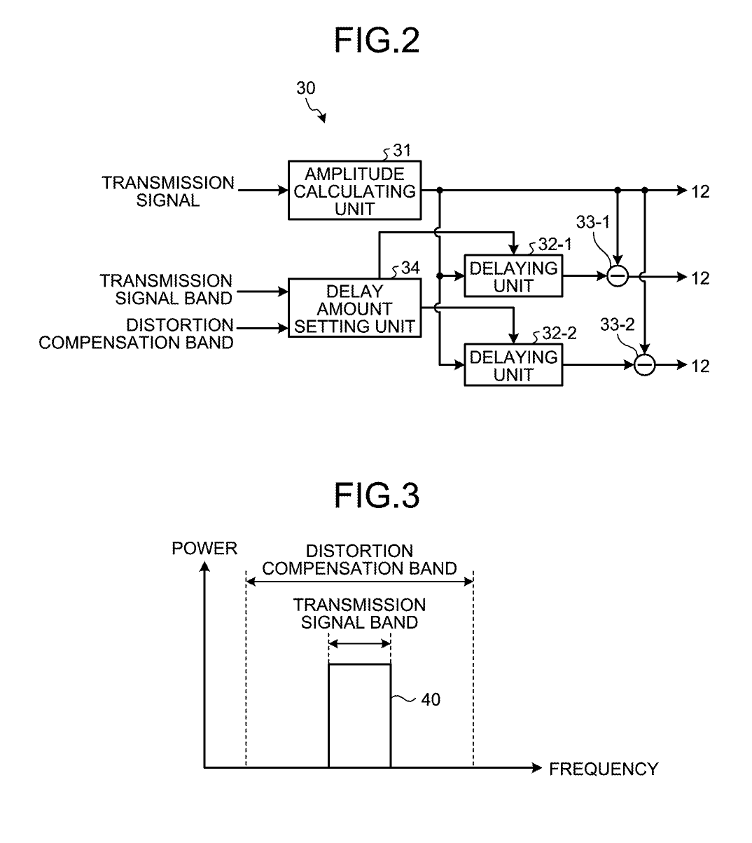

FIG. 2 is a block diagram illustrating an example of the address generating unit 30 in the second embodiment. The address generating unit 30 according to the second embodiment includes the amplitude calculating unit 31, the delaying unit 32-1, the delaying unit 32-2, the subtractor 33-1, the subtractor 33-2, and a delay amount setting unit 34. Except for points to be explained below, blocks in FIG. 2 that have the same reference signs as those in FIG. 1 have the same functions as such blocks in FIG. 1, and explanation thereof will be omitted.

When the difference between the amplitudes of transmission signals in one of the combinations each including transmission signals at different timings is calculated, the delay amount setting unit 34 controls the interval between the timings with respect to the one combination, based on a transmission signal band and a distortion compensation band. The delay amount setting unit 34 is an example of a determining unit. Specifically, based on information on a transmission signal band and a distortion compensation band that has been received from a processing unit that processes a protocol and the like, the delay amount setting unit 34 determines a first time period ΔT1 to be used by the delaying unit 32-1 and a second time period ΔT2 to be used by the delaying unit 32-2. The delay amount setting unit 34 outputs the determined first time period ΔT1 to the delaying unit 32-1 and outputs the determined second time period ΔT2 to the delaying unit 32-2. The delaying unit 32-1 delays, by the first time period ΔT1 output from the delay amount setting unit 34, a value for the amplitude of a transmission signal calculated by the amplitude calculating unit 31. The delaying unit 32-2 delays, by the second time period ΔT2 output from the delay amount setting unit 34, the value for the amplitude of the transmission signal calculated by the amplitude calculating unit 31.

The transmission signal band and the distortion compensation band will be explained here. FIG. 3 is a diagram explaining examples of the transmission signal band and the distortion compensation band. The transmission signal band is a frequency band determined by a signal contained in the transmission signal and having the smallest time period therein, for example, as illustrated as a waveform 40 in FIG. 3. The signal contained in a transmission signal and having the smallest time period therein may sometimes be called a chip hereinbelow. The distortion compensation band is a frequency band determined by the sampling rates of the DAC 13 and the ADC 20, for example, as illustrated in FIG. 3. As illustrated in FIG. 3, the distortion compensation band is wider than the transmission signal band.

The delay amount setting unit 34 determines, for example, (1/the distortion compensation band), as the first time period ΔT1. The value (1/the distortion compensation band) corresponds to the time difference between adjacent samples. Given that the first time period ΔT1 is (1/the distortion compensation band), if x(n) denotes sampled data of a transmission signal x, a piece of difference information Δx1 that is calculated by the subtractor 33-1 is expressed by, for example, Mathematical Formula (1) given below.

Δx1=|x(n)|−|x(n−1)| (1)

where |x(n)| represents the amplitude of the sampled data x(n).

The delay amount setting unit 34 further determines a time ΔT calculated using Mathematical Formula (2) given below, using a variable k (1<k<2), as the second time period ΔT2.

ΔT=k/(the transmission signal band) (2)

Here, the variable k is a value such that the value Δn of Mathematical Formula (3) given below is an integer.

Δn=k ×(the distortion compensation band)/(the transmission signal band) (3)

Consequently, another piece of difference information Δx2 that is calculated by the subtractor 33-2 is expressed by, for example, Mathematical Formula (4) given below.

Δx2=|x(n)|−|x(n−Δn)| (4)

When transmission signals are considered on a chip-to-chip basis, the piece of difference information Δx2 calculated by the subtractor 33-2 corresponds to the difference between the amplitude of the current sample of a transmission signal and the amplitude of a sample within a period of a chip (hereinafter, a chip period) immediately before a chip period in which the current sample of a transmission signal is contained.

Alternatively, the delay amount setting unit 34 may determine a time ΔT calculated using Mathematical Formula (2) with respect to a variable k, for example, such that 0<k<1 and such that the value Δn of Mathematical Formula (3) is an integer, as the first time period ΔT1.

### Effects of Second Embodiment

As described above, in the distortion compensation device 10 according to a second embodiment, when the difference between the amplitudes of transmission signals in one of the combinations each including transmission signals at different timings is calculated, the address generating unit 30 controls the interval between the timings with respect to the one combination, based on a transmission signal band and a distortion compensation band. The distortion compensation device 10 is thus enabled to lengthen the interval between transmission signals between which the difference in amplitude is calculated when the transmission signal band is narrow. On the other hand the distortion compensation device 10 is enabled to shorten the interval in transmission signals between which the difference in amplitude is calculated when the transmission signal band is wide. Therefore, the distortion compensation device 10 is capable of compensating distortion according to time periods of change in amplitude of a transmission signal, and is capable of achieving higher distortion compensation performance.

Furthermore, the distortion compensation device 10 determines (1/the distortion compensation band), as the first time period ΔT1, and determines a time ΔT calculated using Mathematical Formula (2) with respect to the variable k, for example, such that 1<k<2 and such that the value Δn of Mathematical Formula (3) is an integer, as the second time period ΔT2. The distortion compensation device 10 thus compensates distortion based not only on the difference between the amplitudes of the current sample and an adjacent sample of a transmission signal but also on the difference between the amplitudes of the current sample of the transmission signal and a sample thereof within an adjacent chip period. The distortion compensation device 10 is thus enabled to compensate a memory effect having a time constant that spans a plurality of chip periods.

### Third Embodiment

The distortion compensation device 10 according to a third embodiment differs from the distortion compensation device 10 according to the second embodiment in that a value for the variable k is adjusted so that the error between a transmission signal and a signal output from the amplifier 16 can be minimized. The entire configuration of the distortion compensation device 10 is the same as the one according to the first embodiment except for the address generating unit 30, and the configuration of the address generating unit 30 will therefore be mainly explained below.

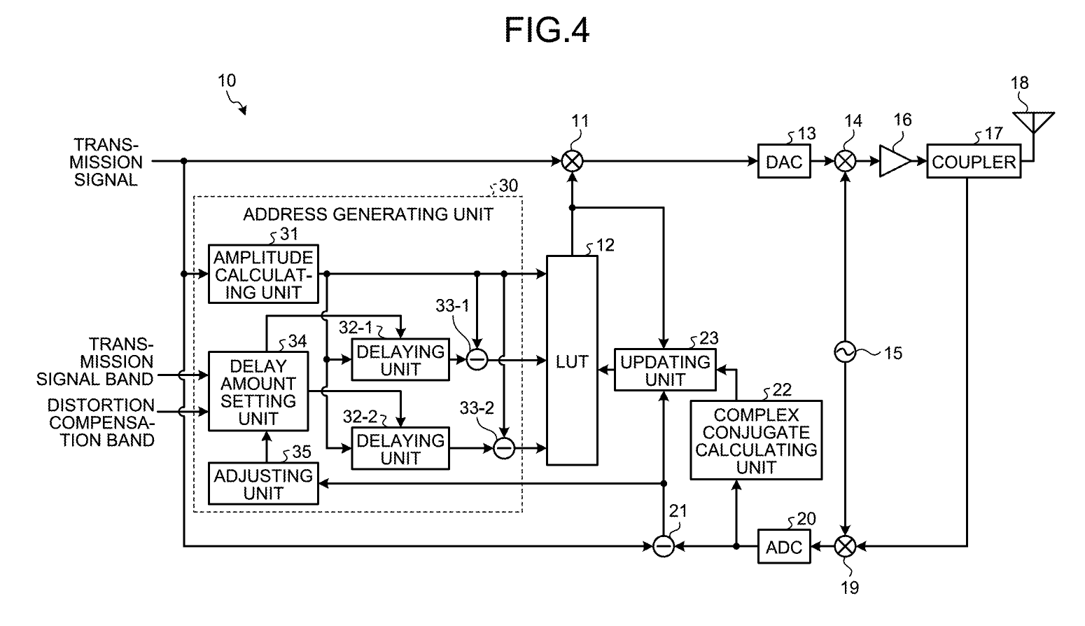

FIG. 4 is a block diagram illustrating an example of the distortion compensation device 10 in the third embodiment. The address generating unit 30 included in the distortion compensation device 10 according to the third embodiment includes the amplitude calculating unit 31, the delaying unit 32-1, the delaying unit 32-2, the subtractor 33-1, the subtractor 33-2, the delay amount setting unit 34, and an adjusting unit 35. Except for points to be explained below, blocks in FIG. 4 that have the same reference signs as those in FIG. 1 or FIG. 2 have the same functions as such blocks in FIG. 1 or FIG. 2, and explanation thereof will be omitted.

The adjusting unit 35 adjusts a value for the variable k, based on an error signal output from the subtractor 21. Specifically, the adjusting unit 35 adjusts a value for the variable k so as to minimize the error between a transmission signal and a signal output from the amplifier 16 under the conditions that 1<k<2 and that the value An of Mathematical Formula (3) is an integer.

For example, the adjusting unit 35 specifies a plurality of values for the variable k under the conditions that 1<k<2 and that the value An of Mathematical Formula (3) is an integer. The adjusting unit 35 selects the specified values for the variable k one by one, and outputs one selected value for the variable k to the delay amount setting unit 34 at a time. The adjusting unit 35 then retains a value of the error signal output from the subtractor 21 while associating this value with the selected value for the variable k. The adjusting unit 35 then specifies the smallest value of the error signal among values of the error signal that are associated with the respective values for the variable k. The adjusting unit 35 then determines a value for the variable k that is associated with the smallest value of the error signal.

It is preferable that the adjusting unit 35 adjust values for the variable k at certain timings. The certain timings include, for example, when a communication apparatus that includes the distortion compensation device 10 is adjusted before shipment, and when the communication apparatus is powered on. Alternatively, the certain timings may include, for example, when the power of a transmission signal has changed by a certain value, when the ambient temperature has changed by a certain value, and when a certain time period has elapsed since the previous update of a value for the variable k.

The delay amount setting unit 34 receives information on a transmission signal band and a distortion compensation band from the processing unit that processes a protocol and the like. The delay amount setting unit 34 then determines (1/the distortion compensation band), as the first time period ΔT1 to be used by the delaying unit 32-1. The delay amount setting unit 34 then outputs the first time period ΔT1 to the delaying unit 32-1.

The delay amount setting unit 34 further receives a value for the variable k from the adjusting unit 35. Based on the transmission signal band and the value for the variable k, the delay amount setting unit 34 then determines a time ΔT calculated using Mathematical Formula (2), as the second time period ΔT2. The delay amount setting unit 34 outputs the determined second time period ΔT2 to the delaying unit 32-2.

### Effects of Third Embodiment

As described above, in the distortion compensation device 10 according to the third embodiment, the subtractor 21 calculates the error between a transmission signal and a signal output from the amplifier 16, and the adjusting unit 35 adjusts a value for the variable k so as to minimize the error calculated by the subtractor 21. The distortion compensation device 10 is thus enabled to compensate a memory effect having a time constant that spans a plurality of chip periods. In addition, the distortion compensation device 10 adjusts a value for the variable k so as to minimize the error between a signal amplified by the amplifier 16 and a transmission signal, thereby being capable of reducing distortion of a signal output from the amplifier 16 in such a manner as to follow changes in characteristics of the amplifier 16 due to a temperature change and a time-dependent change.

### Fourth Embodiment

The distortion compensation device 10 according to a fourth embodiment differs from the distortion compensation device 10 according to the third embodiment in that a value for the variable k is adjusted so that the distortion component of a signal output from the amplifier 16 can be minimized.

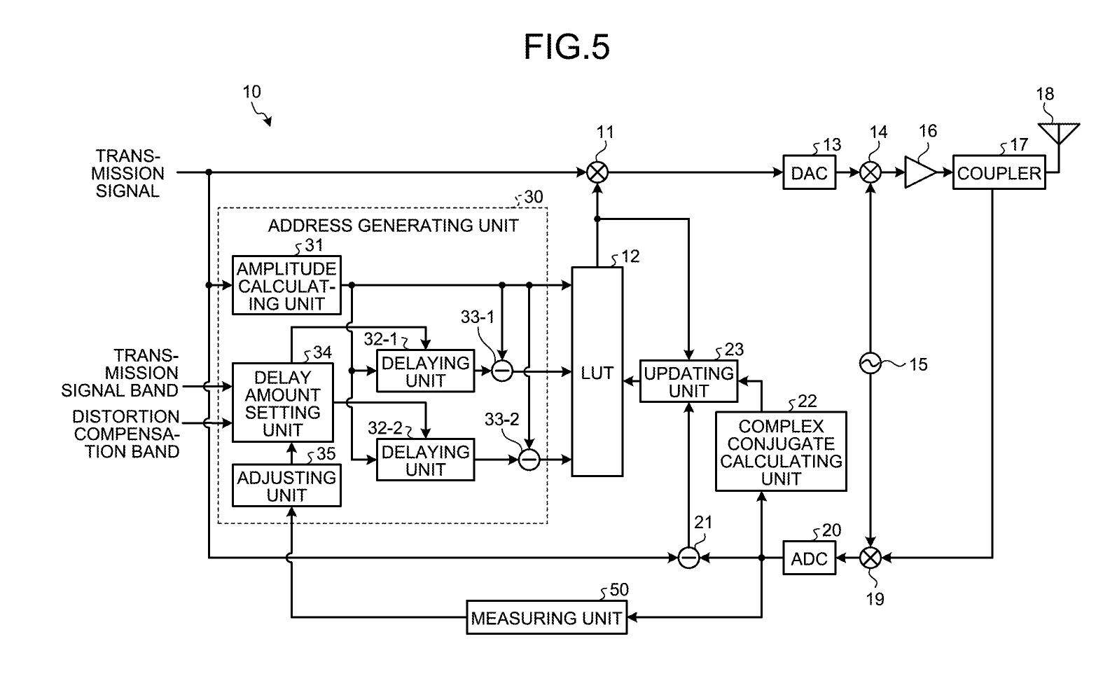

FIG. 5 is a block diagram illustrating an example of the distortion compensation device 10 in the fourth embodiment. The distortion compensation device 10 according to the fourth embodiment includes the multiplier 11, the LUT 12, the DAC 13, the upconverter 14, the oscillator 15, the amplifier 16, the coupler 17, the antenna 18, the downconverter 19, the ADC 20, the subtractor 21, the complex conjugate calculating unit 22, the updating unit 23, the address generating unit 30, and a measuring unit 50. The address generating unit 30 includes the amplitude calculating unit 31, the delaying unit 32-1, the delaying unit 32-2, the subtractor 33-1, the subtractor 33-2, and the delay amount setting unit 34, and the adjusting unit 35. Except for points to be explained below, blocks in FIG. 5 that have the same reference signs as those in FIG. 4 have the same functions as such blocks in FIG. 4, and explanation thereof will be omitted.

The measuring unit 50 measures leakage power outside of a certain band in a signal output from the amplifier 16. Specifically, the measuring unit 50 performs processing such as a fast Fourier transform (FFT) on a signal output from the ADC 20. Based on the signal subjected to the processing, the measuring unit 50 measures, as leakage power, power having frequencies outside the band of a transmission signal. The measuring unit 50 then outputs a value for the measured leakage power to the adjusting unit 35. The measuring unit 50 may measure an ACLR based on the signal output from the ADC 20 and output a value for the measured ACLR to the adjusting unit 35. An ACLR is a ratio of leakage power outside a transmission signal band to power within the transmission signal band, and the value thereof decreases as the power outside the transmission signal band decreases relatively to the power within the transmission signal band.

Based on the value for the leakage power output from the measuring unit 50, the adjusting unit 35 adjusts a value for the variable k. Specifically, the adjusting unit 35 adjusts a value for the variable k so as to minimize the value for the leakage power output from the measuring unit 50 under the conditions that 1<k<2 and that the value Δn of Mathematical Formula (3) is an integer. When a value for the ACLR is output from the measuring unit 50, the adjusting unit 35 determines a value for the variable k so as to minimize the value for the ALCR output from the measuring unit 50 under the conditions that 1<k<2 and that the value Δn of Mathematical Formula (3) is an integer.

The delay amount setting unit 34 receives information on a transmission signal band and a distortion compensation band from the processing unit that processes a protocol and the like. The delay amount setting unit 34 then determines (1/the distortion compensation band), as the first time period ΔT1 to be used by the delaying unit 32-1. The delay amount setting unit 34 then outputs the set first time period ΔT1 to the delaying unit 32-1.

The delay amount setting unit 34 further receives a value for the variable k from the adjusting unit 35. Based on the transmission signal band and the value for the variable k, the delay amount setting unit 34 then determines a time ΔT calculated using Mathematical Formula (2), as the second time period ΔT2. The delay amount setting unit 34 outputs the determined second time period ΔT2 to the delaying unit 32-2.

### Effects of Fourth Embodiment

As described above, in the distortion compensation device 10 according to the fourth embodiment, the measuring unit 50 measures leakage power outside a certain band in a signal output from the amplifier 16, and the adjusting unit 35 adjusts a value for the variable k so as to minimize a value for the leakage power measured by the measuring unit 50. The distortion compensation device 10 is thus enabled to compensate a memory effect having a time constant that spans a plurality of chip periods. The distortion compensation device 10 adjusts a value for the variable k so as to minimize leakage power outside a transmission signal band in a signal amplified by the amplifier 16. The distortion compensation device 10 is thus enabled to reduce distortion of a signal output from the amplifier 16 in such a manner as to follow changes in characteristics of the amplifier 16 due to a temperature change and a time-dependent change.

### Fifth Embodiment

The distortion compensation device 10 according to a fifth embodiment differs from the distortion compensation device 10 according to the first embodiment in that it includes an average amplitude calculating unit 36 in place of the delaying unit 32-2. The entire configuration of the distortion compensation device 10 is the same as the one according to the first embodiment except for the address generating unit 30. For this reason, the configuration of the address generating unit 30 will be mainly explained below.

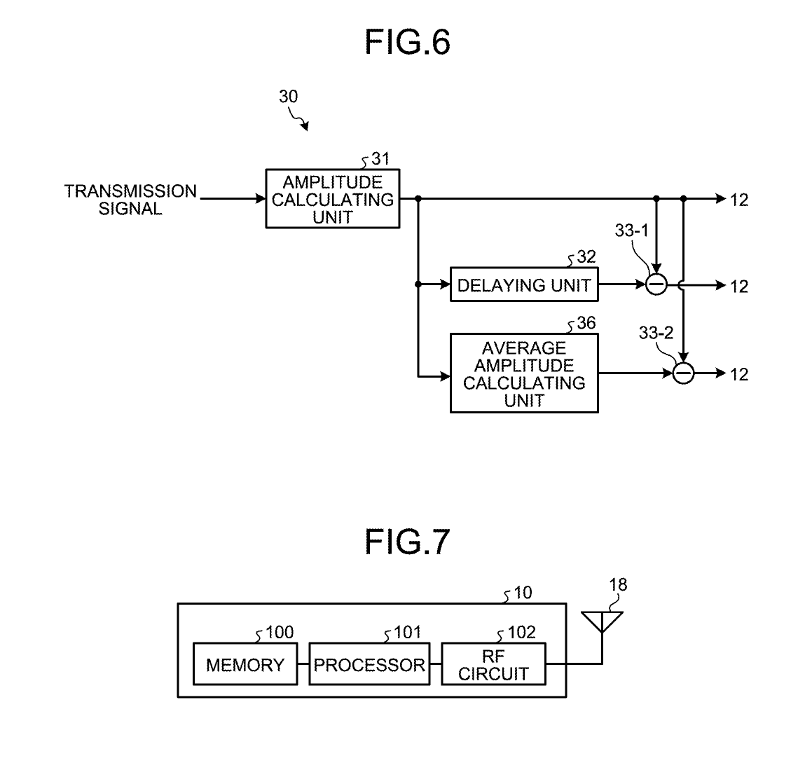

FIG. 6 is a block diagram illustrating an example of the address generating unit 30 in the fifth embodiment. The address generating unit 30 according to the fifth embodiment includes the amplitude calculating unit 31, the delaying unit 32, the subtractor 33-1, the subtractor 33-2, and the average amplitude calculating unit 36. Except for points to be explained below, blocks in FIG. 6 that have the same reference signs as those in FIG. 1 have the same functions as such blocks in FIG. 1, and explanation thereof will be omitted.

The average amplitude calculating unit 36 calculates an average amplitude obtained by averaging amplitudes calculated by the amplitude calculating unit 31 for all samples in a chip period immediately before a chip period that contains a current sample of a transmission signal. The average amplitude calculating unit 36 then outputs the calculated average amplitude to the subtractor 33-2. The average amplitude calculating unit 36 is an example of a second amplitude calculating unit.

The subtractor 33-2 calculates, as a piece of difference information, the difference between a value for the amplitude of a transmission signal calculated by the amplitude calculating unit 31 and a value for the average amplitude calculated by the average amplitude calculating unit 36. The subtractor 33-2 then outputs the calculated piece of difference information, as a third address, to the LUT 12.

### Effects of Fifth Embodiment

As described above, in the distortion compensation device 10 according to the fifth embodiment, the average amplitude calculating unit 36 calculates an average amplitude obtained by averaging amplitudes calculated by the amplitude calculating unit 31 for all samples in a chip period immediately before a chip period that contains a sample of a current transmission signal. The subtractor 33-2 then calculates, as a piece of difference information, the difference between the amplitude calculated by the amplitude calculating unit 31 and the average amplitude calculated by the average amplitude calculating unit 36, and outputs the calculated piece of difference information, as the third address, to the LUT 12. Here, the level of performance in distortion compensation may vary depending on which the amplitude of a sample among a plurality of samples contained in a chip period of a transmission signal is used for generating the address. To eliminate this inconvenience, the distortion compensation device 10 according to the fifth embodiment calculates an average amplitude for all samples in a chip period immediately before a chip period that contains a sample of a current transmission signal, and generates the address using the calculated average amplitude. The distortion compensation device 10 is thus enabled to reduce variation in distortion compensation performance thereof.

Hardware

Next, hardware of each of the distortion compensation devices 10 illustrated in the first to the fifth embodiments will be explained. FIG. 7 is a diagram illustrating the hardware of the distortion compensation device 10. The distortion compensation device 10 includes a memory 100, a processor 101, a radio-frequency (RF) circuit 102, and the antenna 18, for example, as illustrated in FIG. 7.

The RF circuit 102 performs processing such as up-conversion on a signal output from the processor 101, and transmits the signal subjected to the processing through the antenna 18. In addition, the RF circuit 102 includes the amplifier 16 and performs processing such as down-conversion on a signal output from the amplifier 16 and outputting the signal subjected to the processing to the processor 101. The RF circuit 102 implements, for example, the functions of the multiplier 11, the DAC 13, the upconverter 14, the oscillator 15, the amplifier 16, the coupler 17, the downconverter 19, and the ADC 20.

In the memory 100, various computer programs for implementing, for example, the functions of the LUT 12, the subtractor 21, the complex conjugate calculating unit 22, the updating unit 23, and the address generating unit 30 are stored. The processor 101 implements, for example, the functions of the LUT 12, the subtractor 21, the complex conjugate calculating unit 22, the updating unit 23, and the address generating unit 30 by executing the computer programs read out from the memory 100. The distortion compensation device 10 illustrated in FIG. 7 includes the memory 100, the single processor 101, the single RF circuit 102, and the single antenna 18, but may include two or more memories 100, two or more processors 101, two or more RF circuits 102, and two or more antenna 18.

Others

The techniques disclosed herein are not limited to the above embodiments, and may be modified variously without departing from the essence of the techniques.

For example, although the address generating unit 30 in each of the first to the fifth embodiments above calculates, as a piece of difference information, the difference between the amplitudes of transmission signals at different timings in one combination among such combinations, the techniques disclosed herein are not limited to this example. For example, the address generating unit 30 may calculate, as a piece of difference information, the difference between the power of transmission signals at different timings in one combination among such combinations. Specifically, in each of the first to the fifth embodiments, the address generating unit 30 includes, in place of the amplitude calculating unit 31, a power calculating unit that calculates power of a transmission signal, for example. The power calculating unit calculates, for example, the sum of the squares of the I and Q components of a transmission signal as a value for the power thereof.

In this case, the delaying unit 32-1 delays, by the first time period ΔT1, the value for the power of the transmission signal calculated by the power calculating unit. The subtractor 33-1 calculates, as a piece of difference information, the difference between the value for the power of the transmission signal calculated by the power calculating unit and a value for power of the transmission signal obtained by delaying by the delaying unit 32-1, and outputs the calculated piece of difference information, as the second address, to the LUT 12.

In addition, the delaying unit 32-2 delays, by the second time period ΔT2, the value for the power of the transmission signal calculated by the power calculating unit. The subtractor 33-2 calculates, as a piece of difference information, the difference between the value for the power of the transmission signal calculated by the power calculating unit and a value for power of the transmission signal obtained by delaying by the delaying unit 32-2, and outputs the calculated difference information, as the third address, to the LUT 12.

In the fifth embodiment, an average power calculating unit is included in place of the average amplitude calculating unit 36. The average power calculating unit calculates average power obtained by averaging power calculated by the power calculating unit for all samples in a chip period immediately before a chip period that contains a current sample of the transmission signal. The subtractor 33-2 calculates, as a piece of difference information, the difference between the value for the power of the transmission signal calculated by the power calculating unit and a value for the average power calculated by the average power calculating unit, and outputs the calculated piece of difference information, as the third address, to the LUT 12.

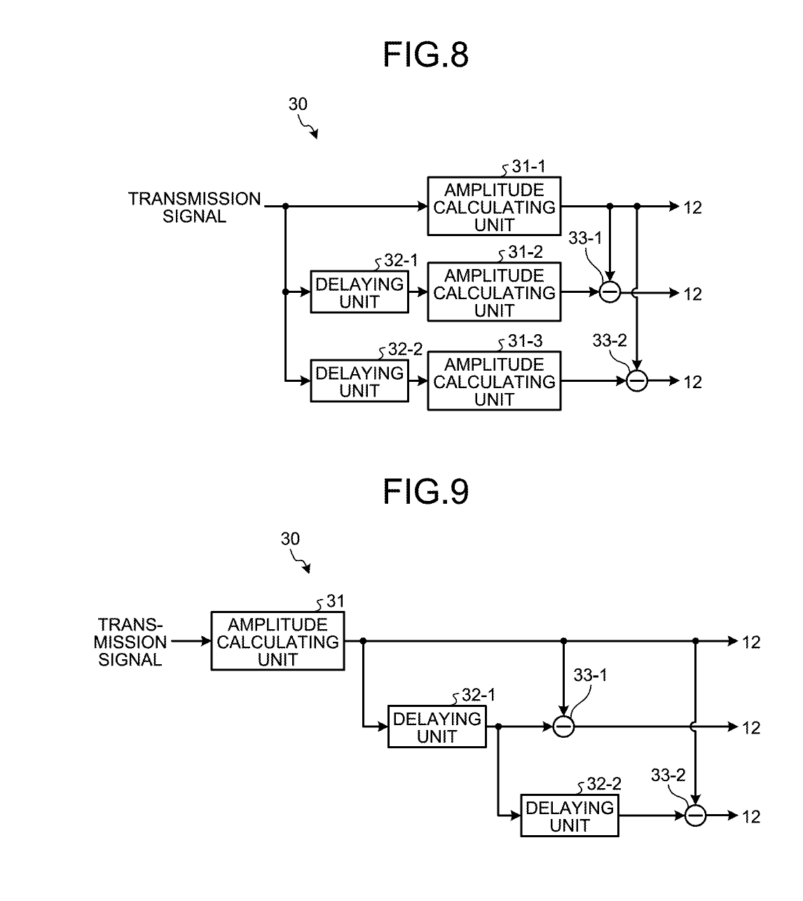

Although the address generating unit 30 in each of the first to the fourth embodiments above calculates the amplitude of a transmission signal and delays the calculated amplitude of the transmission signal by a certain time period, the techniques disclosed herein are not limited to this example. The address generating unit 30 may, for example, delay a transmission signal and then calculate the amplitude of the delayed signal. Specifically, the address generating unit 30 includes a plurality of amplitude calculating units 31-1 to 31-3, for example, as illustrated in FIG. 8.

The delaying unit 32-1 delays a transmission signal by the first time period ΔT1, and the delaying unit 32-2 delays the transmission signal by the second time period ΔT2. The amplitude calculating unit 31-1 calculates the amplitude of the transmission signal and outputs a value for the calculated amplitude of the transmission signal, as the first address, to the LUT 12. The amplitude calculating unit 31-2 calculates the amplitude of a transmission signal obtained by delaying by the first time period ΔT1 by the delaying unit 32-1 and outputs a value for the calculated amplitude of the transmission signal to the subtractor 33-1. The amplitude calculating unit 31-3 calculates the amplitude of a transmission signal obtained by delaying by the second time period ΔT2 by the delaying unit 32-2 and outputs a value for the calculated amplitude of the transmission signal to the subtractor 33-2.

The subtractor 33-1 calculates, as a piece of difference information, the difference between a value for the amplitude of the transmission signal calculated by the amplitude calculating unit 31-1 and a value for the amplitude calculated by the amplitude calculating unit 31-2, and outputs the calculated piece of difference information, as the second address, to the LUT 12. The subtractor 33-2 calculates, as another piece of difference information, the difference between the value for the amplitude of the transmission signal calculated by the amplitude calculating unit 31-1 and a value for the amplitude of the transmission signal calculated by the amplitude calculating unit 31-3, and outputs the calculated piece of difference information, as the third address, to the LUT 12.

Although the delaying unit 32-2 in each of the first to the fourth embodiments above delays, by the second time period ΔT2, the amplitude of a transmission signal calculated by the amplitude calculating unit 31, the techniques disclosed herein are not limited to this example. The delaying unit 32-2 may further delay an amplitude of the transmission signal obtained by delaying by the first time period ΔT1 by the delaying unit 32-1, for example, as illustrated in FIG. 9. In the example illustrated in FIG. 9, the delaying unit 32-2 delays the amplitude of the transmission signal obtained by delaying by the first time period ΔT1 by the delaying unit 32-1 so that the total delay time can be the second time period ΔT2.

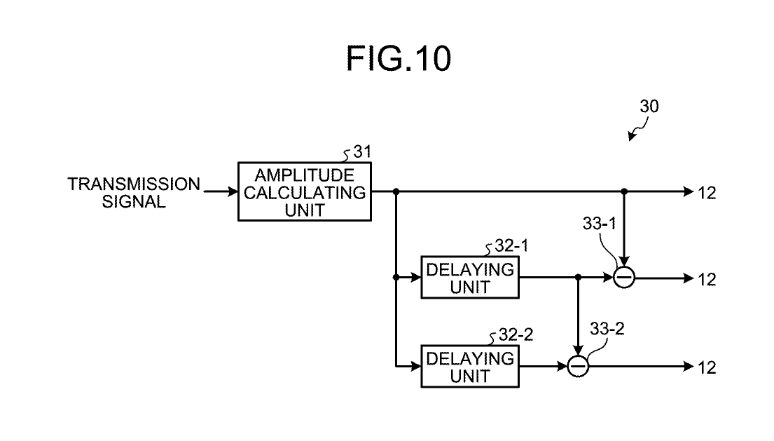

Although the address generating unit 30 in each of the first to the fourth embodiments above calculates, as a piece of difference information, the difference between the amplitude of a transmission signal and the amplitude of a signal obtained by delaying the transmission signal by a certain time period, the techniques disclosed herein are not limited to this example. The address generating unit 30 may calculate, as a piece of difference information, the difference between the amplitude of a signal obtained by delaying a transmission signal by the first time period ΔT1 and the amplitude of a signal obtained by delaying the transmission signal by the second time period ΔT2. Specifically, the subtractor 33-2 calculates, as a piece of difference information, the difference between the amplitude of a transmission signal obtained by delaying by the first time period ΔT1 by the delaying unit 32-1 and the amplitude of a transmission signal obtained by delaying by the second time period ΔT2 by the delaying unit 32-2, for example, as illustrated in FIG. 10. The subtractor 33-2 then outputs the calculated piece of difference information, as a third address, to the LUT 12.

According to the aspects disclosed herein, higher performance can be achieved in distortion compensation performed on an amplifier.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A distortion compensation device comprising:
a calculating unit that calculates pieces of difference information for different combinations each including transmission signals at different timings, the pieces of difference information each being a difference in amplitude or power between the transmission signals in a corresponding one of the combinations; and
a specifying unit that specifies a distortion compensation coefficient by using the pieces of difference information calculated by the calculating unit; and
a distortion compensation unit that performs predistortion, using the distortion compensation coefficient specified by the specifying unit, on the transmission signals to be input to an amplifier.

2. The distortion compensation device according to claim 1, wherein,
the calculating unit controls an interval between the different timings corresponding to each of the combinations, based on a transmission signal band and a distortion compensation band, the transmission signal band being a frequency band of the transmission signals, the distortion compensation band being a frequency band determined by a sampling rate for the transmission signals.

3. The distortion compensation device according to claim 2, wherein the calculating unit includes
an amplitude calculating unit that calculates amplitudes of the transmission signals,
a determining unit that, based on the transmission signal band and the distortion compensation band, determines a first time period and a second time period,
a first delaying unit that delays, by the first time period determined by the determining unit, each of the amplitudes calculated by the amplitude calculating unit,
a second delaying unit that delays, by the second time period determined by the determining unit, each of the amplitudes calculated by the amplitude calculating unit,
a first difference calculating unit that calculates, as one of the pieces of difference information, a difference between each of the amplitudes calculated by the amplitude calculating unit and the corresponding amplitude delayed by the first delaying unit, and
a second difference calculating unit that calculates, as one of the pieces of difference information, a difference between each of the amplitudes calculated by the amplitude calculating unit and the corresponding amplitude delayed by the second delaying unit, and
while the first time period is a time period ΔT calculated using a second mathematical formula with respect to a variable k such that 0<k<1 and such that Δn of a first mathematical formula is an integer, the second time period is the time period ΔT calculated using the second mathematical formula with respect to the variable k such that 1<k<2 and such that Δn of the first mathematical formula is an integer, the first mathematical formula being Δn=k ×(the distortion compensation band)/(the transmission signal band), the second mathematical formula being ΔT=k/(the transmission signal band).

4. The distortion compensation device according to claim 3, wherein the first time period is 1 divided by the distortion compensation band.

5. The distortion compensation device according to claim 4, further comprising:
an error calculating unit that calculates an error between each of the transmission signals and a corresponding signal output from the amplifier, wherein
the calculating unit includes
an adjusting unit that adjusts a value for the variable k so as to minimize the error calculated by the error calculating unit, and
the second delaying unit delays, using the second time period obtained by applying the value for the variable k adjusted by the adjusting unit, the corresponding amplitude calculated by the amplitude calculating unit.

6. The distortion compensation device according to claim 4, further comprising:
a measuring unit that measures leakage power in a signal output from the amplifier, the leakage power being outside a predetermined band, wherein
the calculating unit includes
an adjusting unit that adjusts a value for the variable k so as to minimize the leakage power measured by the measuring unit, and
the second delaying unit delays, using the second time period obtained by applying the value for the variable k adjusted by the adjusting unit, the corresponding amplitude calculated by the amplitude calculating unit.

7. The distortion compensation device according to claim 1, wherein the calculating unit includes
a first amplitude calculating unit that calculates amplitudes of the transmission signals;
a delaying unit that delays, by a certain time period, each of the amplitudes calculated by the first amplitude calculating unit;
a second amplitude calculating unit that calculates an average amplitude obtained by averaging amplitudes calculated by the first amplitude calculating unit for all samples in a time period immediately before a time period that contains a sample of a current one of the transmission signals;
a first difference calculating unit that calculates, as one of the pieces of difference information, a difference between each of the amplitudes calculated by the first amplitude calculating unit and the corresponding amplitude delayed by the delaying unit; and
a second difference calculating unit that calculates, as the pieces of difference information, a difference between each of the amplitudes calculated by the first amplitude calculating unit and the average amplitude calculated by the second amplitude calculating unit.
